(19) United States
(12) Patent Application Publication
(10) Pub. No.: US 2015/0332433 A1
(43) Pub. Date: Nov. 19, 2015

(54) IMAGING DEVICE

(71) Applicant: KONICA MINOLTA, INC., TOKYO (JP)

(72) Inventors: JUN TAKAYAMA, TAMA-SHI, TOKYO (JP); MOTOHIRO ASANO, OSAKA-SHI, OSAKA (JP); KENJI KONNO, SAKAI-SHI, OSAKA (JP)

(73) Assignee: KONICA MINOLTA, INC., TOKYO (JP)

(21) Appl. No.: 14/651,363

(22) PCT Filed: Nov. 29, 2013
(86) PCT No.: PCT/JP2013/007030

§ 371 Date: Jun. 11, 2015

(30) Foreign Application Priority Data
Dec. 14, 2012 (JP) 2012-273378

(51) Int. Cl. G06T 3/40; H04N 5/247; H04N 9/04; H04N 9/07

(52) U.S. Cl. CPC G06T 3/4038; H04N 9/07; H04N 5/247; H04N 9/045

(57) ABSTRACT

An RGB mosaic filter is disposed on one imaging element (301) of an imaging element array (11). An R, G or B one-color filters is disposed on each of the remaining imaging elements (302). In a mode for capturing a moving image, image data captured by the one imaging element (301) is displayed on a display, and, in a mode for capturing a still image, plural pieces of image data captured by all of the image elements (30) are integrated by super-resolution processing, and the integrated image data is displayed on the display.

### TECHNICAL FIELD

The present invention relates to an imaging device comprising an imaging element array configured such that a plurality of imaging elements are arrayed.

### BACKGROUND ART

Generally, a mobile device, such as a mobile phone or a smartphone, includes a camera module as standard equipment. In recent years, there has been an increasing need for mobile devices to have a smaller thickness. Along with this, the camera module is also required to be reduced in thickness.

For example, the following Patent Literature 1 discloses an imaging device comprising: a camera array configured such that a plurality of imaging elements are arrayed; and a plurality of lens elements each corresponding to a respective one of the imaging elements, wherein each of the imaging elements comprises a one-color (monochromatic) filter. In this imaging device, plural pieces of image data are acquired from the respective imaging elements, and integrated to generate a single piece of high-definition image date.

In the imaging device disclosed in the Patent Literature 1, a one-color filter is disposed on each of the imaging elements, so that it is only necessary for each of the lens elements to adapt to one spectral sensitivity characteristic. This facilitates a reduction in size of the lens element.

The following Patent Literature 2 discloses an image input device in which a one-color filter is disposed on each of a plurality of units each consisting of a plurality of light-receiving cells. In the Patent Literature 2, a one-color filter is disposed on each of the units to thereby facilitate a reduction in size of each lens, as with the Patent Literature 1.

However, in each of the Patent Literatures 1 and 2, only a one-color signal can be obtained from each of the imaging elements. Thus, in a situation where it is attempted to obtain a color image, it is necessary to integrate plural pieces of image data captured by the imaging elements on each of which one of at least three different color filters is disposed. Further, when the plural pieces of image data obtained from the imaging elements are integrated to synthesize a single piece of image data, it is necessary to utilize synthetic processing, e.g., a processing of aligning and adding the plural pieces of image data, and super-resolution processing.

For example, in the super-resolution processing, although depending on the number of pixels in each of the plural pieces of image data, it takes several minutes or more to synthesize a single piece of image data, in some cases. In regard to such processing, a still image does not face any major problem, whereas a moving image requiring real-time processing confronts a serious problem.

### CITATION LIST

### Patent Literature

Patent Literature 1: JP 2011-523538A
Patent Literature 2: JP 3705766B

### SUMMARY OF INVENTION

It is an object of the present invention to provide an imaging device comprising an imaging element array configured such that a plurality of imaging elements are arrayed, wherein the imaging device is capable of producing a color image at high speeds.

According to one aspect of the present invention, there is provided an imaging device which comprises: a plurality of optical systems arranged in a matrix pattern; and an imaging element array comprising an array of imaging elements each corresponding to a respective one of the optical systems, wherein the imaging element array includes a first imaging element on which at least two types of color filters each having a different spectral characteristic are disposed, and a second imaging element on which one type of color filter is disposed.

In this aspect, the present invention makes it possible to produce a color image at high speeds in an imaging device comprising an imaging element array configured such that a plurality of imaging elements are arrayed.

### BRIEF DESCRIPTION OF DRAWINGS

FIG. 1 is a schematic diagram illustrating an imaging device according to one embodiment of the present invention.

FIG. 2 is a diagram illustrating a first example of an arrangement pattern of color filters of the imaging device according to the embodiment.

FIG. 3 is a diagram illustrating a second example of the arrangement pattern of the color filters of the imaging device according to the embodiment.

FIG. 4 is a diagram illustrating a third example of the arrangement pattern of the color filters of the imaging device according to the embodiment.

FIG. 5 is a block diagram of the imaging device in the case where the arrangement pattern in FIG. 2 is employed.

FIG. 6 is a diagram illustrating a fourth example of the arrangement pattern of the color filters of the imaging device according to the embodiment.

FIG. 7 is a diagram illustrating a fifth example of the arrangement pattern of the color filters of the imaging device according to the embodiment.

FIG. 8 is a diagram illustrating a sixth example of the arrangement pattern of the color filters of the imaging device according to the embodiment.

FIG. 9 is a block diagram of the imaging device in the case where the arrangement pattern in FIG. 3 is employed.

FIG. 10 is a block diagram of the imaging device in the case where the arrangement pattern in FIG. 4 is employed.

### DESCRIPTION OF EMBODIMENTS

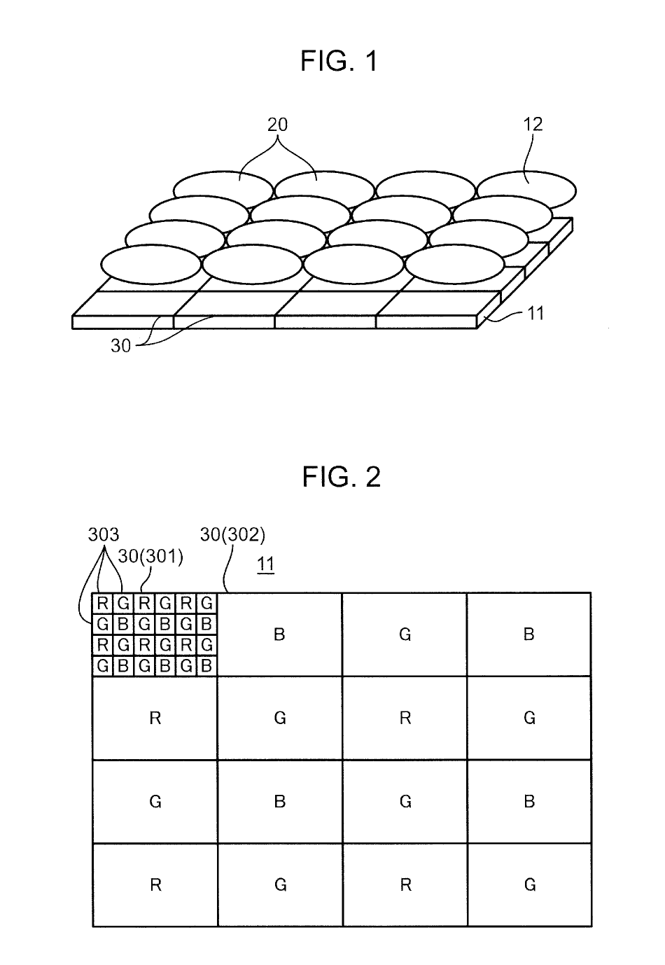

FIG. 1 is a schematic diagram illustrating an imaging device according to one embodiment of the present invention. The imaging device comprises: an imaging element array 11 for capturing an image of an object; and an arrayed lens 12 provided on the side of the light-receiving surface of the imaging element array 11. The arrayed lens 12 comprises a plurality of lenses 20 (as one example of “plurality of optical systems”) arranged in a matrix pattern. The imaging element array 11 comprises a plurality of imaging elements 30 each corresponding to a respective one of the lenses 20.

In this embodiment, the imaging element array 11 is configured such that the plurality of imaging elements 30 are arranged in a matrix pattern, for example, in M rows×N columns (where M is an integer of 2 or more, and N is an integer of 2 or more). Further, each of the lenses 20 is provided correspondingly to a respective one of the imaging elements 30. In this embodiment, as the lens 20, a single lens may be employed, or a lens group composed of a combination of a plurality of lenses may be employed.

The imaging element 30 comprises a plurality of pixels arrayed, for example, in m rows×n columns (where m is an integer of 2 or more, and n is an integer of 2 or more). For examples, as the imaging element 30, it is possible to employ a CMOS-type imaging element or a CCD-type imaging element. The imaging elements 30 may be constructed by dividing one imaging element into a plurality of light-receiving regions formed on the same substrate, or by forming a plurality of imaging elements on the same substrate, or by arranging on the same plane a plurality of imaging elements formed on respective separate substrates. Respective angles of view of the arrayed lenses 12 are adjusted to enable capture of images of approximately the same object. Thus, plural pieces of image data captured by the respective imaging elements 30 represent approximately the same object.

FIG. 2 is a diagram illustrating a first example of an arrangement pattern of color filters of the imaging device according to this embodiment. In the first example of the arrangement pattern, an RGB mosaic filter array is disposed on the one of the imaging elements 30 located at an intersection of the 1st row and the 1st column, and a R (red), G (green) or B (blue) one-color filter is disposed on each of the remaining imaging elements 30. Hereinafter, the imaging element 30 having the RGB mosaic filter array disposed thereon and the imaging element 30 having the one-color filter disposed thereon will hereinafter be mentioned as “imaging element 301” and “imaging element 302”, respectively.

In this embodiment, the R, G or B one-color filters disposed on the imaging elements 302 are arranged in a Bayer array. R, G and B color filters of the RGB mosaic filter array disposed on the imaging element 301 are also arranged in a Bayer array. As the Bayer array, it is possible to employ one type in which G color filters are arranged in a checkered pattern, and R and B color filters are arranged in the remaining regions at a ratio of 1:1. However, it is to be understood that this is merely one example. For example, it is possible to employ a Bayer array in which color filters to be arranged in a checkered pattern are B or R color filters.

Specifically, in the 1st row, the RGB mosaic filter array, and the B, G and B one-color filters are arranged in this order from the 1st column to the 4th column, and, in the 2nd row, the R, G, R and G one-color filters are arranged in this order from the 1st column to the 4th column. In the 3rd row, the G, B, G and B one-color filters are arranged in this order from the 1st column to the 4th column, and, in the 4th row, the R, G, R and G one-color filters are arranged in this order from the 1st column to the 4th column.

The imaging element 301 is divided, for example, into 4 rows×6 columns photoelectric conversion regions (pixels) 303, and the R, G or B one-color filter is disposed on each of the photoelectric conversion regions 303. In this embodiment, the imaging element 301 comprises a plurality of pixels arranged in a matrix pattern of given number m of rows×given number n of columns. Each of the pixels is disposed in a respective one of the photoelectric conversion regions 303. In the embodiment illustrated in FIG. 2, the imaging element 301 comprises a plurality of pixels arrayed in 4 rows×6 columns. However, it is to be understood that this is merely one example. For example, the plurality of pixels may be arrayed in such a manner that the number of pixels of the imaging element 301 becomes equivalent to about 1 MB.

As above, in the imaging element array 11 illustrated in FIG. 2, the RGB mosaic filter array is disposed on one 301 of the imaging elements. Thus, for example, in a mode for capturing a moving image, a color image can be obtained by using only image data acquired by the imaging element 301, without performing the processing of integrating plural pieces of image data. On the other hand, in a mode for capturing a still image, a high-definition color image can be obtained by integrating plural pieces of image data captured by all of the imaging elements 30.

The imaging element 301 is equivalent to one example of “first imaging element on which at least two types of color filters each having a different spectral characteristic are disposed”. Further, the imaging element 302 is equivalent to one example of “second imaging element on which one type of color filter is disposed”.

In FIG. 2, the RGB mosaic filter array is disposed on only one of the imaging elements 30. However, it is to be understood that this is merely one example. For example, it may be disposed on each of two or more (e.g., two or three) of the imaging elements 30. Further, in FIG. 2, the RGB mosaic filter array is disposed on one of the imaging elements 30 located at the intersection of the 1st row and the 1st column. However, it is to be understood that this is merely one example. For example, the RGB mosaic filter array may be disposed on one of the imaging elements 30 located at another position such as a position around a center of the imaging element array.

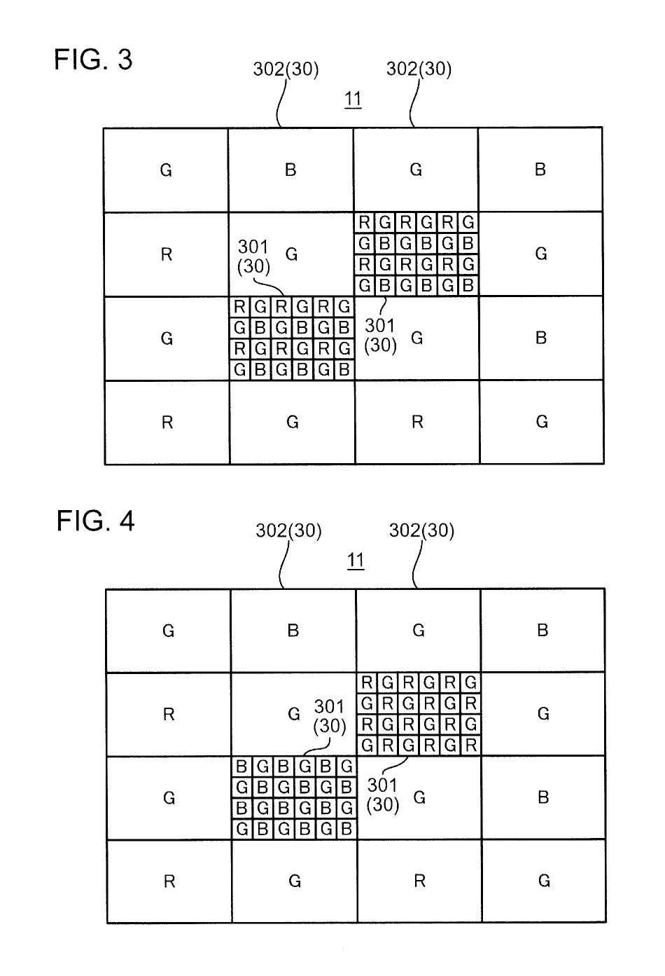

FIG. 3 is a diagram illustrating a second example of the arrangement pattern of the color filters of the imaging device according to this embodiment. In the second example of the arrangement pattern, an RGB mosaic filter array is disposed on each of two 301 of the imaging elements located at an intersection of the 2nd row and the 3rd column and at an intersection of the 3rd row and the 2nd column, and a R (red), G (green) or B (blue) one-color filter is disposed on each 302 of the remaining imaging elements. In other respects, the second example is the same as the arrangement pattern illustrated in FIG. 2. In the arrangement pattern illustrated in FIG. 3, the RGB mosaic filter arrays are provided in a central region of the imaging element array 11. Therefore, in the mode for capturing a moving image, a color image is obtained by integrating two pieces of image data captured by the two imaging elements 301, so that it becomes possible to obtain a color image with a high S/N ratio, even in a dark scene. Thus, the arrangement pattern illustrated in FIG. 3 is effective in a dark scene.

FIG. 4 is a diagram illustrating a third example of the arrangement pattern of the color filters of the imaging device according to this embodiment. In the third example of the arrangement pattern, an RG mosaic filter array is disposed on one 301 of the imaging elements located at the intersection of the 2nd row and the 3rd column, and a BG mosaic filter array is disposed on one 301 of the remaining imaging elements located at the intersection of the 3rd row and the 2nd column. In other respects, the third example is the same as the arrangement pattern illustrated in FIG. 2.

In this example, the imaging element 301 at the intersection of the 2nd row and the 3rd column is configured such that R color filters and G color filters are arranged in a checkered pattern. Specifically, in the imaging element 301 at the intersection of the 2nd row and the 3rd column, R and G color filters are arranged in such a manner that, in the 1st row, the R color filter and the G color filter are alternately arranged from the first column to the fourth column, and, in the second row, the G color filter and the R color filter are alternately arranged from the first column to the fourth column.

The imaging element 301 at the intersection of the 3rd row and the 2nd column is configured such that B color filters and G color filters are arranged in a checkered pattern. Specifically, in the imaging element 301 at the intersection of the 3rd row and the 2nd column, B and G color filters are arranged in such a manner that, in the 1st row, the B color filter and the G color filter are alternately arranged from the first column to the fourth column, and, in the second row, the G color filter and the B color filter are alternately arranged from the first column to the fourth column.

In the arrangement pattern illustrated in FIG. 4, there are two imaging elements 301 on each of which a two-color mosaic filter array is disposed. In the case where such a two-color mosaic filter array is employed, a wavelength band of light to be transmitted therethrough becomes narrower than that in the case where the three-color mosaic filter array is employed. Therefore, it becomes possible to facilitate a reduction in size of the lens 20. On the other hand, the lens 20 may be set to have a thickness equal to that in the case where the three-color mosaic filter array is employed. In this case, performance of the lens 20 can be enhanced.

In the arrangement pattern illustrated in FIG. 4, it is unable to obtain B color information from the imaging element 301 at the intersection of the 2nd row and the 3rd column, and it is unable to obtain R color information from the imaging element 301 at the intersection of the 3rd row and the 2nd column. However, when the two imaging elements 301 is subjected to synthetic processing, information about R, G and B colors can be obtained, so that it becomes possible to obtain an RGB color image. Therefore, in the arrangement pattern illustrated in FIG. 4, in the mode for capturing a moving image, a color image can be obtained by integrating image data obtained from the imaging element 301 at the intersection of the 2nd row and the 3rd column, and image data obtained from the imaging element 301 at the intersection of the 3rd row and the 2nd column.

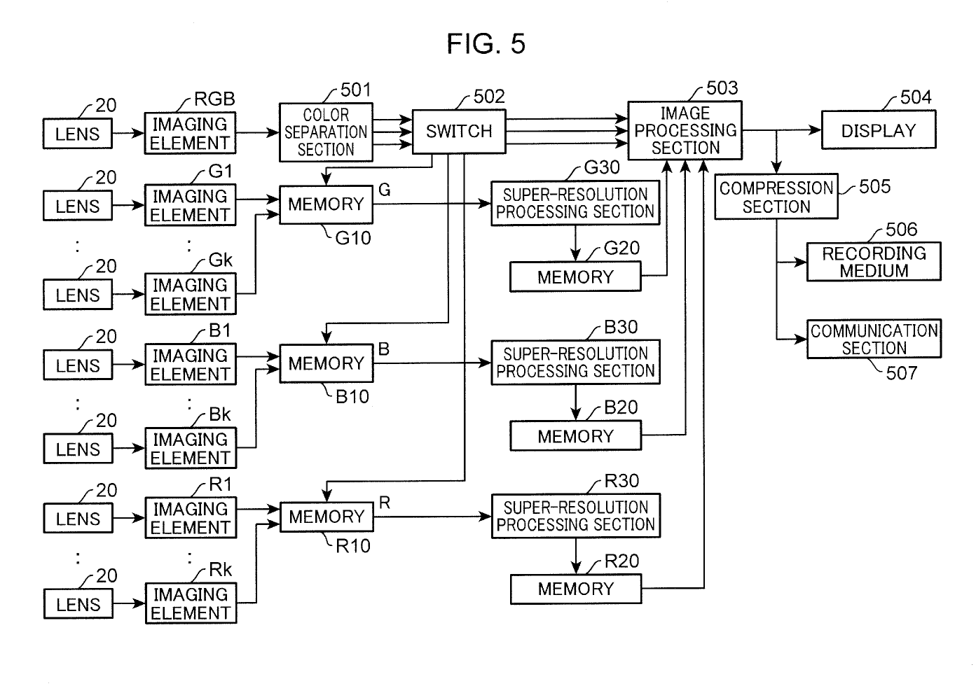

FIG. 5 is a block diagram of the imaging device in the case where the arrangement pattern in FIG. 2 is employed. The imaging device comprises a lens 20, an imaging element RGB, imaging elements G1 to Gk (where k is an integer of 2 or more), imaging elements B1 to Bk, imaging elements R1 to Rk, a color separation section 501, a switch 502, an image processing section 503, a display 504, a compression section 505, a recording medium 506, a communication section 507, memories G10, B10, R10, super-resolution processing sections G30, B30, R30, and memories G20, B20, R20.

The lens 20 is provided correspondingly to each of the imaging element RGB, the imaging elements G1 to Gk, the imaging elements B1 to Bk and the imaging elements R1 to Rk. The imaging element RGB corresponds to the imaging element 301 in FIG. 2. The imaging elements G1 to Gk correspond to the imaging elements 302 in FIG. 2 on each of which the G color filter is disposed. The imaging elements B1 to Bk correspond to the imaging elements 302 in FIG. 2 on each of which the B color filter is disposed. The imaging elements R1 to Rk correspond to the imaging elements 302 in FIG. 2 on each of which the R color filter is disposed.

The color separation section 501 is configured to separate image data captured by the imaging element RGB, into three, R, G and B, color components. The switch 502 is configured to connect the color separation section 501 to the image processing section 503, in the mode for capturing a moving image. Thus, R, G and B color components separated by the color separation section 501 are output to the image processing section 503.

The switch 502 is also configured to connect the color separation section 501 to the memories G10, B10, R10, in the mode for capturing a still image. Thus, R, G and B color components separated by the color separation section 501 are written into the memories R10, G10, B10, respectively.

The image processing section 503 is configured to, in the mode for capturing a moving image, subject image data consisting of the R, G and B color components separated by the color separation section 501, to given image processing to produce a color image, and output the color image to the display 504. The image processing section 503 is also configured to, in the mode for capturing a still image, read three pieces of super-resolved image data, respectively, from the memories G20, B20, R20, and, after subjecting the read image data to gamma correction to produce a color image, output the color image to the display 504.

In this embodiment, examples of the given image processing include color interpolation and gamma correction. For example, as the color interpolation, it is possible to employ a processing of interpolating missing pixels in the image data consisting of the separated R, G and B color components. For example, as the gamma correction, it is possible to employ a processing of correcting an image characteristic of image data obtained by each of the imaging elements 30 to a characteristic suitable for output characteristics of the display 504. Further, the image processing section 503 is configured to additionally output the image-processed image data to the compression section 505, as needed.

The memory G10 is an image memory configured to hold image data consisting of the G color component obtained by the imaging element RGB, and k pieces of image data obtained by the imaging elements G1 to Gk. The memory B10 is an image memory configured to hold image data consisting of the B color component obtained by the imaging element RGB, and k pieces of image data obtained by the imaging elements B1 to Bk. The memory R10 is an image memory configured to hold image data consisting of the R color component obtained by the imaging element RGB, and k pieces of image data obtained by the imaging elements R1 to Rk.

The super-resolution processing section G30 is configured to subject image data held by the memory G10 to the super-resolution processing to produced a single piece of G-component super-resolved image data, and write the produced image data in the memory G20. The super-resolution processing section B30 (R30) is configured to produce a single piece of B-component (R-component) super-resolved image data, from image data held by the memory B10 (R10), and write the produced image data in the memory B20 (R20), in the same manner as that in the super-resolution processing section G30. In this embodiment, although depending on lens performance with respect to a resolution of the imaging element 30, each of the super-resolution processing sections G30, B30, R30 is configured to generate image data, for example, having a sub-pixel level of resolution which is about 5 times greater than the resolution of the imaging element 30. For allowing each of the super-resolution processing sections G30, B30, R30 to generate a sub-pixel level of image data, it is preferable that misalignment between two pieces of image data captured by the adjacent imaging elements 30 is at a sub-pixel level.

In the example illustrated in FIG. 5, the super-resolution processing sections G30, B30, R30 are provided. Alternatively, a G addition section, a B addition section and an R addition section may be provided to integrate respective sets of image data held by the memories G10, B10, R10 to thereby synthesize a single piece of image data. In this case, an amount of misalignment between a reference one of the imaging elements 30 and each of the remaining imaging elements 30 is preliminarily stored in each of the G addition section, the B addition section and the R addition section. Then, each of the G addition section, the B addition section and the R addition section may be operable to align k pieces of image data captured by the imaging elements 30, using the amount of misalignment, and then add the aligned image data to thereby synthesize a single piece of image data.

The memory G20 is configured to store therein the super-resolved G image data. Each of the memory B20 and the memory R20 is configured to store therein a respective one of the super-resolved B image data and the super-resolved R image data, in the same manner as that in the memory G20.

The compression section 505 is configured to compress image data output from the image processing section 503. In this embodiment, a variety of data compression methods may be employed in the compression section 505. For example, for a moving image, the compression section 505 may be configured to compress image data by a method such as H.264 or Motion JPEG. For a still image, the compression section 505 may be configured to compress image data by a method such as JPEG.

The display 504 is constructed by employing various types of displays such as a liquid crystal panel and an organic EL panel, and configured to display image data output from the image processing section 503. The recording medium 506 is composed, for example, of a stationary, rewritable storage device such as a hard disk, or a portable, rewritable storage device such as a memory card, and configured to store therein image data compressed by the compression section 505.

The communication section 507 is composed, for example, of a wireless LAN or wired LAN communication module, or a mobile phone communication module, and configured to send image data compressed by the compression section 505 to the outside, and receive image data from the outside.

Next, an operation of the imaging device in the mode for capturing a moving image will be described. First of all, an object is imaged, i.e., image data about the object is captured, by the imaging element RGB. The captured image data is separated into R, G and B color components by the color separation section 501, and image data consisting of the R, G and B color components is input into the image processing section 503 via the switch 502. Then, the image data input into the image processing section 503 is subjected to gamma correction and color interpolation, and formed as processed image data consisting of R, G and B color components, and the processed image data is displayed on the display 504. Further, for example, in response to a storage instruction input by a user, the processed image data is compressed by the compression section 505 and then stored in the recording medium 506. On the other hand, for example, in response to a sending instruction input by a user, the processed image data is sent to the outside by the communication section 507.

Next, an operation of the imaging device in the mode for capturing a still image will be described. First of all, an image of an object is captured by all of the imaging elements 30 to acquire plural pieces of image data. G image data captured by the imaging element RGB and k pieces of G image data captured by the imaging elements G1 to Gk are stored in the memory G10 once. Similarly, B image data captured by the imaging element RGB and k pieces of B image data captured by the imaging elements B1 to Bk are stored in the memory B10 once, and R image data captured by the imaging element RGB and k pieces of R image data captured by the imaging elements R1 to Rk are stored in the memory R10 once.

Then, the super-resolution processing section G30 integrates the plural pieces of G image data stored in the memory G10, based on the super-resolution processing, to thereby synthesize a single piece of G image data, and writes the single piece of G image data into the memory G20. Similarly, the super-resolution processing section B30 (R30) integrates the plural pieces of B (R) image data stored in the memory B10 (R10) to thereby synthesize a single piece of B (R) image data, and writes the single piece of B (R) image data into the memory B20 (R20).

Then, the super-resolved G, B and R image data stored in the memories G20, B20, R20 is subjected to image processing, such as gamma correction and color interpolation, through the image processing section 503, and displayed on the display 504. The super-resolved G, B and R image data after being subjected to the image processing through the image processing section is stored in the recording medium 506, or sent to the outside by the communication section 507, as needed.

Although the above imaging device is configured to, in the mode for capturing a still image, integrate plural pieces of image data captured by all of the imaging elements 30, the present invention is not limited thereto, but image data captured by the imaging element RGB may be used as data for a still image. For example, in the case where the captured image data is uploaded to an operating site of a social network, high image quality is not required for the captured image data. Thus, image data captured by the imaging element RGB may be used as data for a still image without any problem.

Switching between capture of a moving image and capture of a still image may be achieved, for example, by providing a manual operation section in the imaging device in such a manner as to allow a user to manually operate the manual operation section so as to select one of a moving image mode and a still image mode.

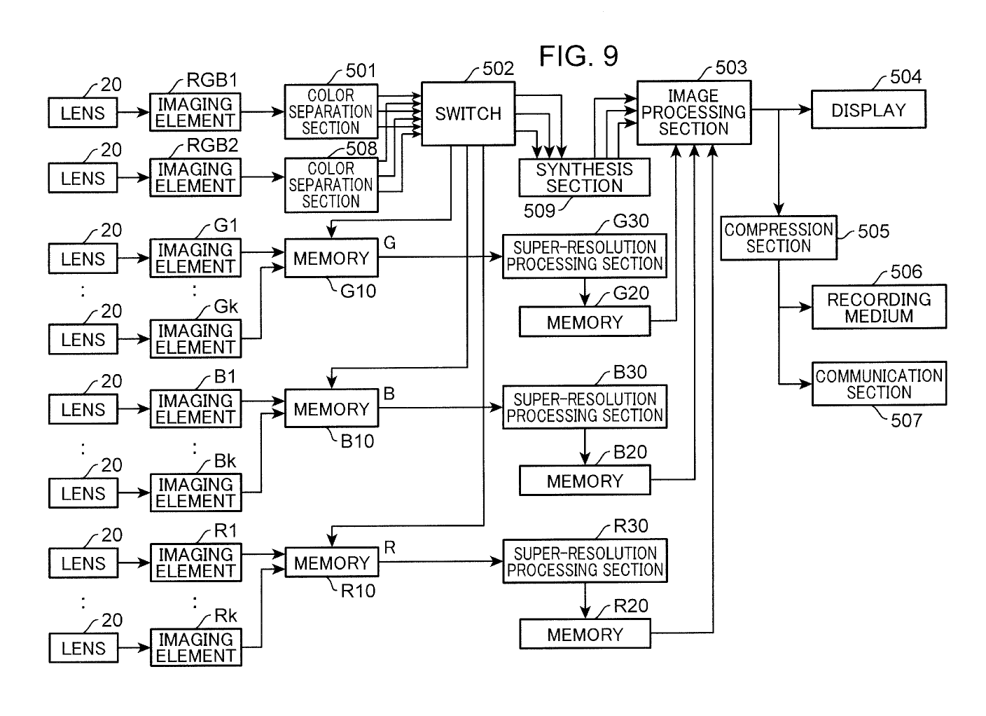

FIG. 9 is a block diagram of the imaging device in the case where the arrangement pattern in FIG. 3 is employed. In FIG. 9, two imaging elements RGB1, RGB2 are provided, so that two color separation sections 501, 508 are provided correspondingly to the respective imaging elements RGB1, RGB2. Further, in FIG. 9, a synthesis section 509 is provided to integrate two pieces of image data captured by the imaging elements RGB1, RGB2. For example, the imaging element RGB1 corresponds to the imaging element 301 at the intersection of the 2nd row and the 3rd column in FIG. 3, and the imaging element RGB2 corresponds to the imaging element 301 at the intersection of the 3rd row and the 2nd column in FIG. 3. In FIG. 9, description about the same element or component as that in FIG. 5 will be omitted.

A switch 502 is configured to, in the mode for capturing a moving image, connect each of the color separation section 501 and the color separation section 508 to the synthesis section 509. The switch 502 is also configured to, in the mode for capturing a still image, connect each of the color separation section 501 and the color separation section 508 to memories G10, B10, R10.

The color separation section 501 is configured to separate image data captured by the imaging element RGB1 into three, R, G and B, color components. The color separation section 508 is configured to separate image data captured by the imaging element RGB2 into R, G and B color components.

The memory G10 is configured to hold two pieces of image data each consisting of the G color component separated by a respective one of the color separation section 501 and the color separation section 508, and k pieces of image data each consisting of the G color component captured by a respective one of a plurality of imaging elements G1 to Gk.

Each of the memory B10 and the memory R10 is configured to hold a respective one of image data consisting of B color components and image data consisting of R color components.

The synthesis section 509 is configured to, in the mode for capturing a moving image, integrate image data consisting of R, G and B color components separated by the color separation section 501, and image data consisting of R, G and B color components separated by the color separation section 508, to thereby synthesize a single piece of image data. More specifically, an amount of misalignment between the imaging element RGB1 and the imaging element RGB2 is preliminarily stored in the synthesis section 509. Then, the color separation section 508 is operable to align the image data separated by the color separation section 501 and the image data separated by the color separation section 508, using the amount of misalignment, and add the aligned image data on a color component-by-color component basis to thereby synthesize a single piece of image data consisting of R, G and B color components. In this case, it is only necessary for the synthesis section 509 to perform the alignment and addition processing, so that it is possible to synthesize a single piece of image data under a low processing load. However, it is to be understood that this is merely one example. For example, the synthesis section 509 may be configured to, based on super-resolution processing, integrate image data captured by the imaging element RGB1, and image data captured by the imaging element RGB2. The use of the super-resolution processing causes an increase in processing load, as compared to the alignment and addition processing. However, considering that the processing load becomes lower along with a decrease in the number of images (pixels) of the imaging elements RGB1, RGB2, the synthesis section 509 may employ the super-resolution processing without any problem, under a limited condition (e.g., in the case where a frame rate is relatively small).

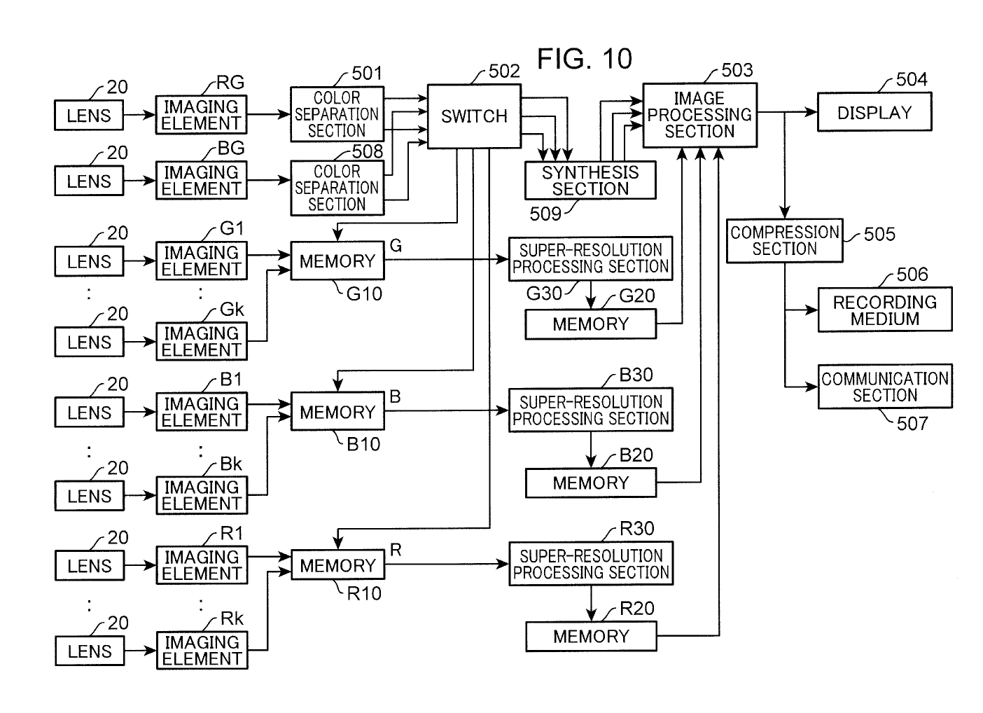

FIG. 10 is a block diagram of the imaging device in the case where the arrangement pattern in FIG. 4 is employed. In FIG. 10, two imaging elements RG, BG are provided, so that two color separation sections 501, 508 are provided correspondingly to the respective imaging elements RG, BG Further, in FIG. 10, a synthesis section 509 is provided to integrate two pieces of image data captured by the imaging elements RG, BG In FIG. 10, description about the same element or component as that in FIG. 9 will be omitted.

In the imaging device illustrated in FIG. 10, the synthesis section 509 is configured to, in the mode for capturing a moving image, generate two pieces of image data each consisting of a G color component, from two pieces of image data captured by two of the imaging elements 30, i.e., the imaging element RG and the imaging element BG, while generating image data consisting of a B color component, from image data captured by the imaging element BG, and generating image data consisting of an R color component, from image data captured by the imaging element RG. In this case, it is only necessary for the synthesis section 509 to add the two pieces of image data each consisting of the G color component. It is to be understood that the synthesis section 509 may be configured to, based on super-resolution processing, integrate the two pieces of image data each consisting of the G color component.

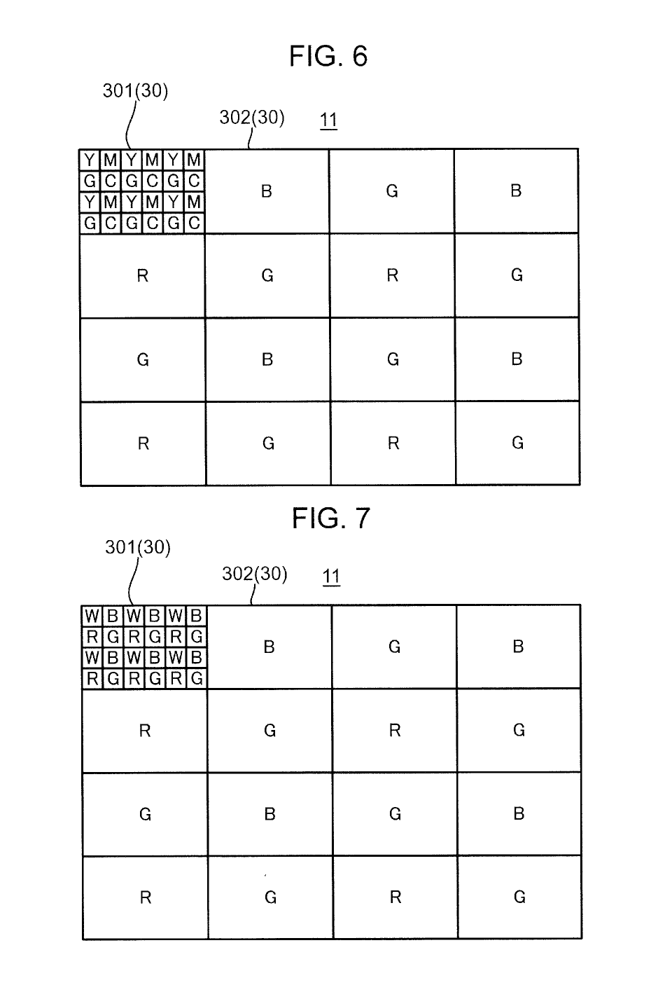

FIG. 6 is a diagram illustrating a fourth example of the arrangement pattern of the color filters of the imaging device according to this embodiment. In the fourth example of the arrangement pattern, a YMGC mosaic filter array is disposed on one of the imaging elements 30 located at an intersection of the 1st row and the 1st column, and an R, G or B one-color filter is disposed on each of the remaining imaging elements 30. In other respects, the fourth example is the same as the arrangement pattern illustrated in FIG. 2.

In the YMCG mosaic filter array, color filters having respective spectral characteristics for transmitting Y (yellow) light, M (magenta) light, C (cyan) light and G (green) light are arrayed. In the example illustrated in FIG. 6, the Y, M, C and G color filters are arrayed in 4 rows×6 columns. However, it is to be understood that this is merely one example, and the filters may be arrayed in any other suitable pattern and/or in any other suitable pixel number.

In the case where the arrangement pattern in FIG. 6 is employed, an imaging device having the configuration illustrated in the block diagram of FIG. 5 may be employed. Specifically, in FIG. 5, the imaging element RGB is replaced with the imaging element 301 on which the YMCG mosaic filter array illustrated in FIG. 6 is disposed. The imaging element 301 having the YMCG mosaic filter array disposed thereon will hereinafter be referred to as “imaging element YMCG”. The color separation section 501 is configured to separate image data captured by the imaging element YMCG, into four, Y, M, C and G, color components. The image processing section 503 is configured to, in the mode for capturing a moving image, convert the four, Y, M, C and G, color components separated by the color separation section 501, to three, R, G and B, color components, by arithmetic processing, and display on the display 504 an image obtained by subjecting the R, G and B color components to image processing such as gradation conversion. The processing of converting the four, Y, M, C and G, color components to the three, R, G and B, color components may be performed by the color separation section 501.

The color separation section 501 is also configured to, in the mode for capturing a still image, after separating image data captured by the imaging element YMCG, into the four, Y, M, C and G, color components, convert the Y, M, C and G color components to R, G and B color components, by arithmetic processing, and write the R, G and B color components into the memories R10, G10, B10, respectively.

FIG. 7 is a diagram illustrating a fifth example of the arrangement pattern of the color filters of the imaging device according to this embodiment. In the fifth example of the arrangement pattern, a WRGB mosaic filter array is disposed on one of the imaging elements 30 located at an intersection of the 1st row and the 1st column, and an R, G or B one-color filter is disposed on each of the remaining imaging elements 30. In other respects, the fifth example is the same as the arrangement pattern illustrated in FIG. 2.

In the WRGB mosaic filter array, a W (white) region on which no color filter is disposed, and a color filter having a spectral characteristic for transmitting B (blue) light, R (red) light or G (green) light, are arranged in a mosaic pattern. Although the following description will be made on the assumption that a W color filter is disposed in the W region, only for the sake of simplicity of explanation, the W color filter is not actually disposed in the W region.

In the example illustrated in FIG. 7, the W, R, G and B color filters are arrayed in 4 rows×6 columns. However, it is to be understood that this is merely one example, and the filters may be arrayed in any other suitable arrangement pattern.

In the case where the arrangement pattern in FIG. 7 is employed, an imaging device having the configuration illustrated in the block diagram of FIG. 5 may be employed. Specifically, in FIG. 5, the imaging element RGB is replaced with the imaging element 301 on which the WRGB mosaic filter array illustrated in FIG. 7 is disposed. The imaging element 301 having the WRGB mosaic filter array disposed thereon will hereinafter be referred to as “imaging element WRGB”. The color separation section 501 is configured to separate image data captured by the imaging element WRGB, into four, W, R, G and B, color components. The image processing section 503 is configured to, in the mode for capturing a moving image, convert the four, W, R, G and B, color components separated by the color separation section 501, to three, R, G and B, color components, by arithmetic processing, and display on the display 504 an image obtained by subjecting the R, G and B color components to image processing such as gradation conversion. The processing of converting the four, W, R, G and B, color components to the three, R, G and B, color components may be performed by the color separation section 501.

The color separation section 501 is also configured to, in the mode for capturing a still image, after separating image data captured by the imaging element WRGB, into the four, W, R, G and B, color components, convert the W, R, G and B color components to G, B and R color components, and write the G, B and R color components into the memories G10, B10, R10, respectively.

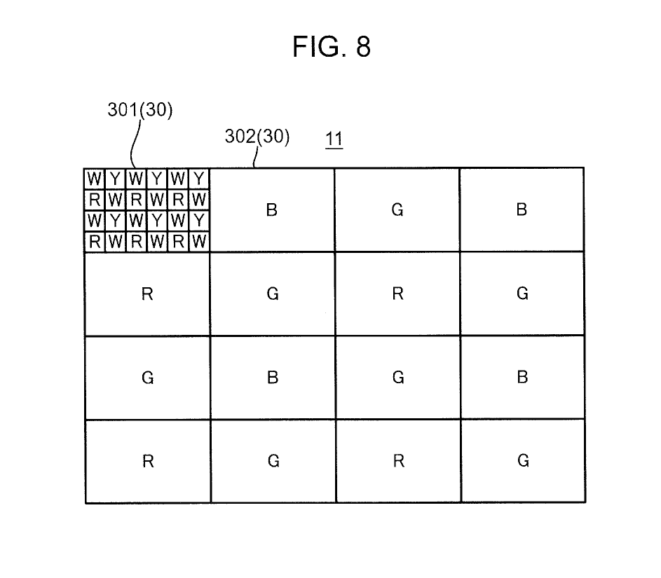

FIG. 8 is a diagram illustrating a sixth example of the arrangement pattern of the color filters of the imaging device according to this embodiment. In the sixth example of the arrangement pattern, a WYR mosaic filter array is disposed on one of the imaging elements 30 located at an intersection of the 1st row and the 1st column, and an R, G or B one-color filter is disposed on each of the remaining imaging elements 30. In other respects, the fifth example is the same as the arrangement pattern illustrated in FIG. 2.

In the WYR mosaic filter array, a W (white) region on which no color filter is disposed, and a color filter having a spectral characteristic for transmitting Y (yellow) light or R (red) light, are arranged in a mosaic pattern. In the example illustrated in FIG. 8, the W color filters are arranged in a checkered pattern, and the R and Y color filters are arranged in the remaining regions at a ratio of 1:1. However, it is to be understood that this is merely one example. For example, color filters to be arranged in a checkered pattern may be the R or Y color filters. Further, in the example illustrated in FIG. 8, the W, Y and R color filters are arrayed in 4 rows×6 columns. However, it is to be understood that this is merely one example, and the filters may be arrayed in any other suitable pattern.

In the case where the arrangement pattern in FIG. 8 is employed, an imaging device having the configuration illustrated in the block diagram of FIG. 5 may be employed. Specifically, in FIG. 5, the imaging element RGB is replaced with the imaging element 301 on which the WYR mosaic filter array illustrated in FIG. 8 is disposed. The imaging element 301 having the WYR mosaic filter array disposed thereon will hereinafter be referred to as “imaging element WYR”. The color separation section 501 is configured to separate image data captured by the imaging element WYR, into three, W, Y and R, color components. The image processing section 503 is configured to, in the mode for capturing a moving image, convert the W, Y and R color components separated by the color separation section 501, to R, G and B color components, by arithmetic processing, and display on the display 504 an image obtained by subjecting the R, G and B color components to image processing such as gradation conversion. The processing of converting the W, Y and R color components to the R, G and B color components may be performed by the color separation section 501.

The color separation section 501 is also configured to, in the mode for capturing a still image, after separating image data captured by the imaging element WYR, into the three, W, Y and R, color components, convert the W, Y and R color components to G, B and R color components, and write the G, B and R color components into the memories G10, B10, R10, respectively.

In each of the arrangement patterns illustrated in FIGS. 6 to 8, the imaging element 301 is disposed at the intersection of the 1st row and the 1st column. However, it is to be understood that this is merely one example, and the imaging element 301 may be disposed at any other suitable position. Further, a plurality of imaging elements 301 may be arranged. In the case where a plurality of imaging elements 301 are arranged, an imaging element having the configuration illustrated in the block diagram of FIG. 9 may be employed.

As above, the imaging device according to this embodiment is configured to, in the mode for capturing a moving image, use image data captured by the imaging element 301 on which an at least two-color mosaic filter array is disposed, so that it becomes possible to suppress a processing load during capture of a moving image to suppress power consumption. In the above embodiment, the number of the imaging elements 301 is set to 1 or 2. However, the number is not limited thereto, but may be set to 3 or mote.

### Outline of Embodiment

(1) The imaging device according to the above embodiment comprises: a plurality of optical systems arranged in a matrix pattern; and an imaging element array comprising an array of imaging elements each corresponding to a respective one of the optical systems, wherein the imaging element array includes a first imaging element on which at least two types of color filters each having a different spectral characteristic are disposed, and a second imaging element on which one type of color filter is disposed.

In this imaging device, the imaging elements are arrayed in a matrix pattern to form the imaging element array. Then, the imaging element array includes the first imaging element having two types of color filters disposed thereon, and the second imaging element having one type of color filter disposed thereon. Therefore, during capture of a moving image requiring high-speed processing, a color image can be synthesized from image data captured by the first imaging element.

That is, when a color image is synthesized from image data captured by the first imaging element, a processing load can be reduced, as compared to the case where a color image is synthesized from image data captured by all of the imaging elements, so that it becomes possible to obtain a color image at high speeds. In addition, the reduction in processing load facilitates power saving.

The number of the first imaging elements may be set to 1. In this case, it becomes possible to eliminate a need to integrate plural pieces of image data, thereby producing a color image at a higher speed. Further, as the second imaging element, a type having a different spectral characteristic from that of the first imaging element may be arranged. In this case, color image data having at least three color components can be generated at high speeds by integrating image data captured by the first imaging element and the second imaging element.

On the other hand, during capture of a still image having a low need for high-speed processing, as compared to a moving image, a high-definition color image can be synthesized from image data captured by all of the imaging elements, through super-resolution processing or the like.

(2) Preferably, the first imaging element is provided with an at least two-color mosaic filter array disposed thereon, and the second imaging element is provided with a one-color filter disposed thereon.

In the imaging device having this feature, the at least two-color mosaic filter array is disposed on the first imaging element, so that a color image having at least two color components can be obtained on a real-time basis. Further, the one-color filter is disposed on the second imaging element, so that a high-definition color image can be obtained by integrating image data obtained from the first imaging element and the second imaging element.

(3) Preferably, the one-color filter disposed on the at least one second imaging element has a same color as one of the colors of the mosaic filter array.

In the imaging device having this feature, the one-color filter disposed on the second imaging element has the same color as one of the colors of the mosaic filter array disposed on the first imaging element, so that higher-definition image data in terms of the color can be obtained by integrating image data obtained from the first imaging element and the second imaging element.

(4) Preferably, the above imaging device is configured to use the first imaging element to obtain image data for a moving image.

In the imaging device having this feature, the first imaging element is used to obtain image data for a moving image. Thus, image data for a moving image can be obtained at a higher speed, as compared to the case where image data for a moving image is generated by integrating image data captured by all of the imaging elements.

(5) Preferably, the first imaging element is provided with an RGB mosaic filter array disposed thereon.

In the imaging device having this feature, the RGB mosaic filter array is disposed on the first imaging element, so that a color moving image having RGB color components can be produced on a real-time basis.

(6) Preferably, the first imaging element is provided in a plural number, wherein at least one of the first imaging elements is provided with a GR mosaic filter array disposed thereon, and each of the remaining first imaging elements is provided with a GB mosaic filter array disposed thereon.

In the imaging device having this feature, two types of color filters are disposed on each of the first imaging elements, so that, as compared to the case where three types of color filters are disposed thereon, a wavelength band of light to be transmitted through the optical system becomes narrower, and thereby the optical system corresponding to the first imaging element can be reduced in size. More specifically, the GR mosaic filter array is disposed on at least one of the first imaging elements, and the GB mosaic filter array is disposed on each of the remaining first imaging elements, so that a color moving image having RGB color components can be produced on a real-time basis by integrating image data captured by the first imaging elements.

(7) Preferably, the first imaging element is provided with an YMCG mosaic filter array disposed thereon.

In the imaging device having this feature, the YMCG mosaic filter array generally having higher sensitivity than an RGB mosaic filter array is disposed on the first imaging element, so that it becomes possible to provide higher sensitivity and obtain image data with good S/N ratio, on a real-time basis.

(8) Preferably, the first imaging element is provided with a WRGB mosaic filter array disposed thereon.

In the imaging device having this feature, it becomes possible to obtain image data consisting of a W (white) color component in addition to image data consisting of R, G and B color components. In this regard, the W color component has a spectral sensitivity in the overall bandwidth. Therefore, it becomes possible to provide higher sensitivity and obtain image data with good S/N ratio, by generating image data consisting of R, G and B color components, using image data consisting of a W color component.

(9) Preferably, the first imaging element is provided with a WYR mosaic filter array disposed thereon.

In the imaging device having this feature, image data consisting of a W color component can be obtained, so that it becomes possible to provide higher sensitivity and obtain image data with good S/N ratio, on a real-time basis.

(10) Preferably, the second imaging element is provided with an R, G or B one-color filter disposed thereon.

In the imaging device having this feature, the R, G or B one-color filter is disposed on the second imaging element, so that a high-definition color image can be obtained by integrating image data obtained from a plurality of the second imaging elements.

1. An imaging device comprising:
a plurality of optical systems arranged in a matrix pattern; and
an imaging element array comprising an array of imaging elements each corresponding to a respective one of the optical systems, wherein
the imaging element array includes a first imaging element on which at least two types of color filters each having a different spectral characteristic are disposed, and a second imaging element on which one type of color filter is disposed.

2. The imaging device as defined in claim 1, wherein
the first imaging element is provided with an at least two-color mosaic filter array disposed thereon, and
the second imaging element is provided with a one-color filter disposed thereon.

3. The imaging device as defined in claim 2, wherein the one-color filter disposed on the at least one second imaging element has a same color as one of the colors of the mosaic filter array.

4. The imaging device as defined in claim 1, which is configured to use the first imaging element to obtain image data for a moving image.

5. The imaging device as defined in claim 1, wherein the first imaging element is provided with an RGB mosaic filter array disposed thereon.

6. The imaging device as defined in claim 1, wherein the first imaging element is provided in a plural number, and wherein at least one of the first imaging elements is provided with a GR mosaic filter array disposed thereon, and each of the remaining first imaging elements is provided with a GB mosaic filter array disposed thereon.

7. The imaging device as defined in claim 1, wherein the first imaging element is provided with an YMCG mosaic filter array disposed thereon.

8. The imaging device as defined in claim 1, wherein the first imaging element is provided with a WRGB mosaic filter array disposed thereon.

9. The imaging device as defined in claim 1, wherein the first imaging element is provided with a WYR mosaic filter array disposed thereon.

10. The imaging device as defined in claim 1, wherein the second imaging element is provided with an R, G or B one-color filter disposed thereon.
